(19) United States
(12) Patent Application Publication
(10) Pub. No.: US 2010/0309171 A1
(43) Pub. Date: Dec. 9, 2010

(54) METHOD OF SCANNING TOUCH PANEL

(75) Inventors: Ming-Ta Hsieh, Taipei County (TW); Chien-Ming Lin, Kaohsiung County (TW); Chih-Chung Chen, Taichung County (TW); Hsueh-Fang Yin, Kaohsiung City (TW); Chia-Lin Liu, Taichung County (TW); Chi-Neng Mo, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Chunghwa Picture Tubes, LTD., Taoyuan (TW)

(21) Appl. No.: 12/546,690

(22) Filed: Aug. 25, 2009

(30) Foreign Application Priority Data
Jun. 8, 2009 (TW) 98119064

(51) Int. Cl. G09G 5/00; G06F 3/041

(52) U.S. Cl. 345/204; 345/173

(57) ABSTRACT

A method of scanning a touch panel is provided. The present method includes following steps. First, a scan area is defined according to the coordinates of a detected touch signal. Next, the scan area is scanned during a predetermined period to detect a next touch panel. After the predetermined period, a sensing range of the touch panel is scanned to re-define the scan area. Because the scan area is smaller than the sensing range of the touch panel, the time and power consumed by the scanning operation can be both reduced by detecting the touch signals within the scan area.

### CROSS-REFERENCE TO RELATED APPLICATION

This application claims the priority benefit of Taiwan application serial no. 98119064, filed Jun. 8, 2009. The entirety of the above-mentioned patent application is hereby incorporated by reference herein and made a part of specification.

### BACKGROUND OF THE INVENTION

1. Field of the Invention

The present invention generally relates to a touch panel scanning method, and more particularly, to a touch panel scanning method wherein a scan area is dynamically adjusted according to a touch signal.

2. Description of Related Art

Along with the development of electronic technology, touch panels have been disposed in most electronic devices (for example, notebook computers, cell phones, or portable multimedia players) to replace the conventional keyboards as the input interfaces. Touch panels can be generally categorized into resistive touch panels, capacitive touch panels, infrared touch panels, and ultrasound touch panels, wherein the resistive touch panels and the capacitive touch panels are the most popular products.

Regarding a capacitive touch panel, when a user gets close to or touches the touch panel with his finger or a conductive material, the capacitance of the touch panel is changed. When the touch panel detects the capacitance change, it determines the position that the user's finger or the conductive material gets close to or touches and executes a functional operation corresponding to the touched position. A capacitive touch panel supports multi-finger touch therefore it can provide a personalized operation interface. Accordingly, capacitive touch panels have been gradually accepted by the users.

Regarding the scanning manner of a projected capacitive touch panel, all the sensor areas of the projected capacitive touch panel are sequentially scanned and which sensor area is touched is then determined according to the scanning result. After that, the single-touch or multi-touch position is calculated according to the touched sensor area. Since all the sensor areas are scanned in the technique described above, the scanning operation will take a long time and the calculation load will be heavy if there is a great number of sensor areas. As a result, the execution efficiency of the touch panel is greatly reduced.

### SUMMARY OF THE INVENTION

Accordingly, the present invention is directed to a method of scanning a touch panel, wherein a scan area is defined according to sensor areas corresponding to a touch signal and an entire image scanning is carried out timely, so that the scanning time and power consumption of the touch panel can be effectively reduced.

The present invention provides a method of scanning a touch panel, wherein the touch panel has a plurality of sensor areas. The method includes: (a) scanning the touch panel to detect whether the sensor areas are touched; (b) defining a scan area according to the coordinates of a touch signal when the touch signal is detected, wherein the coordinates of the touch signal are located within the scan area, and the scan area is smaller than a sensing range of the touch panel; (c) scanning the scan area during a predetermined period to detect whether the sensor areas within the scan area are touched; and (d) returning to step (a) to re-scan all the sensor areas of the touch panel after the predetermined period.

According to an embodiment of the present invention, foregoing step (b) includes: when the touch signal is corresponding to a first sensor area among the sensor areas, defining the scan area according to the coordinates of the first sensor area.

According to an embodiment of the present invention, foregoing step (b) includes: when the touch signal is corresponding to a first sensor area and a second sensor area among the sensor areas, defining the scan area according to the coordinates of the first sensor area and the second sensor area.

According to an embodiment of the present invention, the scan area is a square area, and the step of defining the scan area according to the coordinates of the first sensor area and the second sensor area includes: obtaining a first maximum coordinate and a first minimum coordinate on a first axis and a second maximum coordinate and a second minimum coordinate on a second axis according to the coordinates of the first sensor area and the second sensor area; defining a first border and a second border of the scan area according to the first maximum coordinate and the first minimum coordinate; and defining a third border and a fourth border of the scan area according to the second maximum coordinate and the second minimum coordinate, wherein the first border and the second border are opposite to each other, and the third border and the fourth border are opposite to each other.

According to an embodiment of the present invention, the coordinate of the first border and the first maximum coordinate are different by a predetermined value, and the coordinate of the second border and the first minimum coordinate are different by the predetermined value.

According to an embodiment of the present invention, foregoing step (b) includes: when the touch signal is corresponding to the first sensor area and the second sensor area among the sensor areas, respectively defining a first sub scan area and a second sub scan area of the scan area according to the coordinates of the first sensor area and the second sensor area.

According to an embodiment of the present invention, the first sub scan area and the second sub scan area are square areas, the first sensor area is located at a center of the first sub scan area, and the second sensor area is located at a center of the second sub scan area.

According to an embodiment of the present invention, foregoing step (b) includes: when a second touch signal is detected, adjusting the position of the scan area according to the coordinates of the second touch signal, wherein the coordinates of the second touch signal are located within the adjusted scan area, and the second touch signal is detected after the first touch signal.

The present invention provides a method of scanning a touch panel, wherein the touch panel has a plurality of sensor areas. The method includes: (a) scanning the touch panel to detect whether the sensor areas are touched; (b) when a first touch signal is detected, defining a scan area according to the coordinates of the first touch signal, wherein when the first touch signal is corresponding to a single sensor area, the scan area is smaller than a sensing range of the touch panel, when the first touch signal is corresponding to multiple sensor areas, the scan area is equal to the sensing range of the touch panel, and the coordinates of the touch signal are located within the scan area; (c) scanning the scan area during a predetermined period to detect whether the sensor areas within the scan area are touched; (d) returning to step (a) after the predetermined period to re-scan all the sensor areas of the touch panel.

According to an embodiment of the present invention, the scan area is a square area, and the first sensor area is located at a center of the scan area.

According to an embodiment of the present invention, the touch panel is a projected capacitive touch panel.

According to an embodiment of the present invention, the sensor areas are respectively corresponding to a plurality of sensor units.

As described above, in the present invention, a dynamic area scanning method is adopted to replace the conventional entire image scanning method, so that the system can detect touched positions without having to scan the entire image every time. Thus, both the scanning time and the power consumption of a touch panel are effectively reduced, and the execution efficiency thereof is improved.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart of a method of scanning a touch panel according to an embodiment of the present invention.

FIG. 2 is a flowchart of a method of scanning a touch panel according to another embodiment of the present invention.

FIG. 3 is a diagram illustrating how a scan area is defined in a single-touch state according to the embodiment illustrated in FIG. 2.

FIG. 4 is a diagram illustrating how a scan area is defined in a multi-touch state according to the embodiment illustrated in FIG. 2.

FIG. 5 is a diagram illustrating how another scan area is defined in the multi-touch state according to the embodiment illustrated in FIG. 2.

FIG. 6 is a diagram illustrating how yet another scan area is defined in the multi-touch state according to the embodiment illustrated in FIG. 2.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

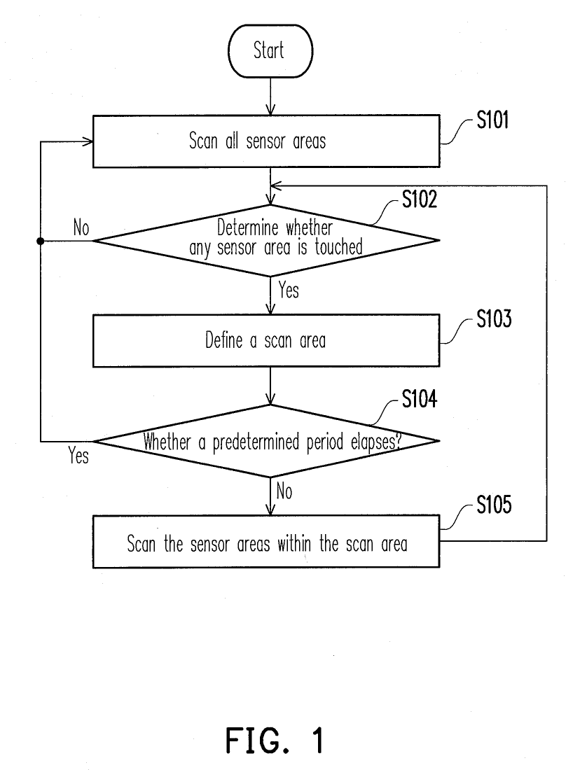

FIG. 1 is a flowchart of a method of scanning a touch panel according to an embodiment of the present invention. Referring to FIG. 1, in the present embodiment, the touch panel is a projected capacitive touch panel. The touch panel has a plurality of sensor areas, and each of the sensor areas has a sensor element for detecting a touch action, wherein the sensor elements may be sensors or other circuit structures with touch detection capability. In the present method, first, all the sensor areas of the touch panel are scanned to detect whether the sensor areas are touched (step S101), wherein whether a sensor area is touched refers to whether the sensor area is gotten close to or touched. When a sensor area is touched, it generates a touch signal; otherwise, it does not generate any touch signal. Accordingly, whether each of the sensor areas is touched can be determined according to whether the sensor area generates any touch signal (step S102).

When a sensor area of the touch panel is touched, the touched sensor area generates a touch signal. Besides, the touch signal is detected when the touched sensor area is scanned. In this case, the touch panel is determined to be in a touched state. Then, a scan area is defined according to the coordinates of the touched sensor area (step S103), wherein the touched sensor area is located within the scan area, and the size of the scan area is smaller than the size of the whole sensing range of the touch panel.

Next, whether the touch panel has stayed in the touched state for a predetermined period is determined (step S104), wherein the predetermined period may be represented by a scanning number (for example, the time consumed for scanning the touch panel for 10 times). When the touch panel is in the touched state and the time for scanning the touch panel for 10 times has not yet elapsed (within the predetermined period), the sensor areas within the scan area are re-scanned (step S105), and whether the sensor areas within the scan area (including foregoing touched sensor area) are touched is determined according to the scanning result (step S102). Thus, when a user touches the touch panel, the scan area is scanned to detect a next touched sensor area, so that the number of sensor areas to be scanned, and accordingly the scanning time, is reduced.

In addition, if the touch panel is in the touched state and the time for scanning the touch panel for 10 times has elapsed (i.e., step S105 has been executed for 10 times), all the sensor areas of the touch panel are scanned when the process returns to step S104 (step S101), so as to detect whether any one of the sensor areas is touched and the scanning number is reset. In other words, during the predetermined period, the sensor areas within the scan area are constantly scanned (step S105), and the scan area is then adjusted according to the scanning result (step S102˜S103). While after the predetermined period elapses, the process returns to step S101 to re-scan all the sensor areas (including foregoing touched sensor area), and the scan area is then re-defined (step S102˜S103). Accordingly, all the sensor areas of the touch panel are re-scanned to detect whether any sensor area outside of the scan area is touched. Because existing electronic devices have very fast processing speed, it takes very short time to scan the touch panel. Thus, when a user touches a sensor area outside of the scan area, the delay in the process is not noticeable to the user. When the process returns to step S102 and no touch signal is detected (i.e., no sensor area of the touch panel is touched), all the sensor areas are scanned (step S101) to detect whether any sensor area is touched.

Generally speaking, when the user operates the touch panel, several sensor areas may be touched at a single touch point, and these touched sensor areas will be represented with the sensor area having the highest weight. However, it is not limited in the present invention that only one sensor area could be touched at a single touch point.

As described above, in the present embodiment, when a touch signal is detected, a temporary scan area is defined according to the touch area corresponding to the touch signal. The scan area is then scanned to detect a next touched sensor area, and the position and size of the scan area are adjusted according to the newly detected touch signal. After that, the entire image is scanned after a predetermined time period to re-define the scan area, so that any touch point outside of the scan area can be detected. In other words, in the present embodiment, the entire image and a smaller scan area are alternatively scanned. When the scan area is scanned, both the power consumption and the scanning time are reduced, and when the user touches at very different points on the touch panel, the entire image is scanned to define a new scan area. Thereby, in the present embodiment, not only the power consumption and the scanning time are both reduced, but touch signals can be correctly detected so that the system will not miss out any touch point even with the reduced scan range.

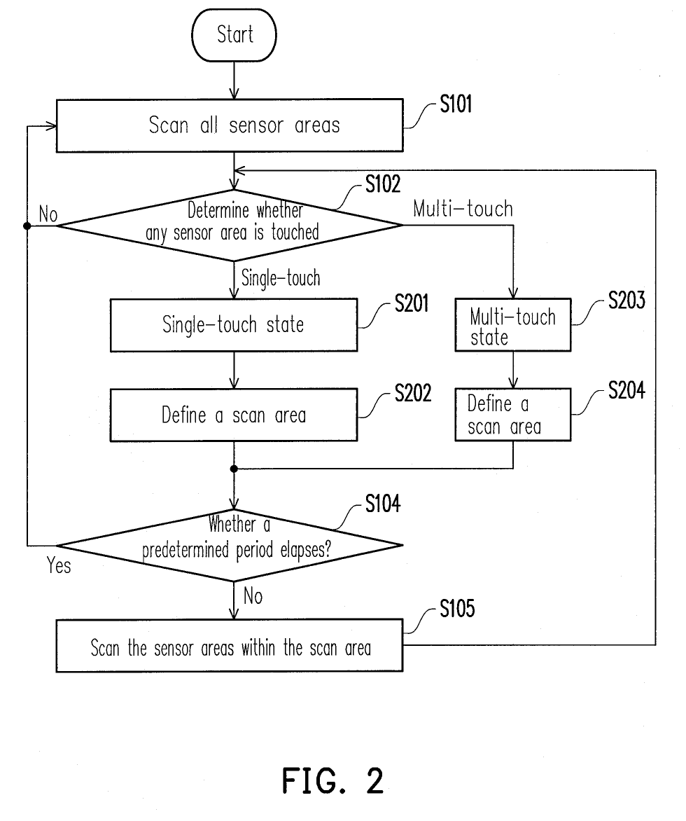

FIG. 2 is a flowchart of a method of scanning a touch panel according to another embodiment of the present invention. Referring to FIG. 1 and FIG. 2, the difference between the two embodiments falls on steps S201˜S204. When the touch panel detects that only one sensor area is touched, the touch panel is determined to be in a single-touch state according to the detected touch signal (step S201). Then, a scan area is defined according to the coordinates of the touched sensor area (step S202). When the touch panel detects that multiple sensor areas are touched, the touch panel is determined to be in a multi-touch state according to the detected touch signal (step S203). Then, the scan area is defined according to the coordinates of the touched sensor areas (step S202).

In other words, the scan area is adjusted according to the detected touch point. The scan area always contains the sensor area(s) touched by the user, and the position of the scan area is constantly adjusted according to the newly detected touch point. In addition, regardless of being in the single-touch state or the multi-touch state, the touch panel in the present embodiment always re-scan the entire image after a predetermined period, wherein the predetermined period may be continuously counted in both the single-touch state and the multi-touch state of the touch panel or respectively counted in these two states.

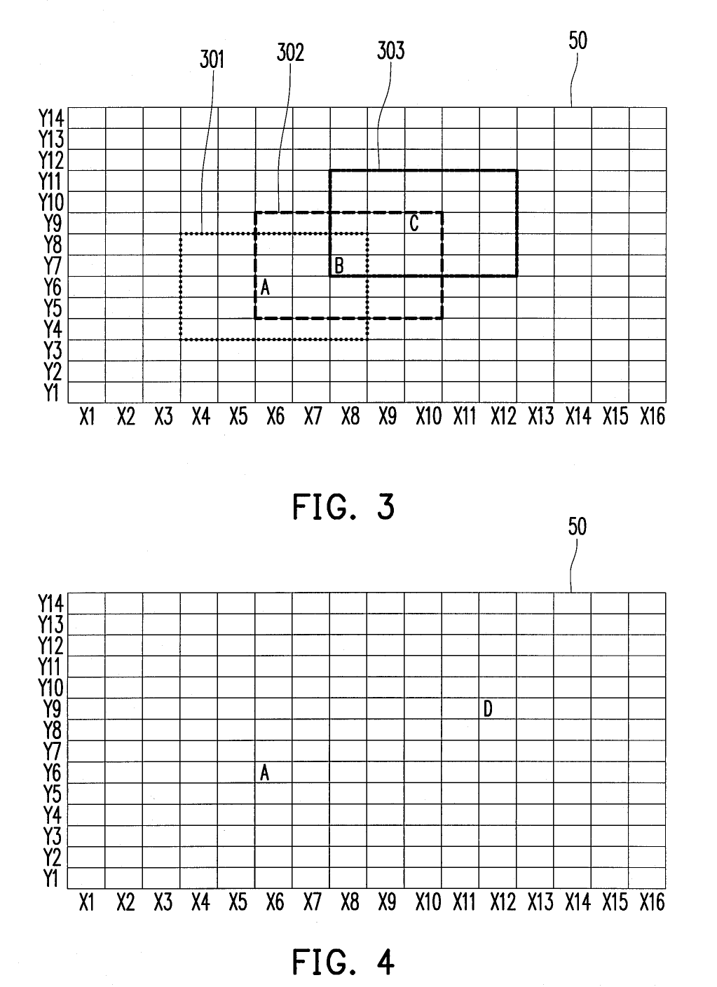

Next, how the scan area is defined when the touch panel is in the single-touch state will be described. FIG. 3 is a diagram illustrating how a scan area is defined in the single-touch state according to the embodiment illustrated in FIG. 2. Referring to FIG. 3, each grid on the touch panel 50 represents a sensor area for detecting a touch action on the touch panel 50, and the symbols X1˜X16 and Y1˜Y14 on the touch panel 50 respectively indicate the coordinates of the sensor areas.

Referring to FIG. 2 and FIG. 3, when the sensor area A of the touch panel 50 is touched, a sensor element within the sensor area A generates a first touch signal. When the sensor area A is scanned, the first touch signal is detected, and the touch panel 50 is determined to be in a single-touch state (step S201). Next, a scan area 301 is defined according to the coordinates of the sensor area A (step S202), wherein the scan area 301 is smaller than a sensing range of the touch panel 50, the sensor area A is located at the center of the scan area 301, and the sensor area A is kept a predetermined value away from each border of the scan area 301. In the present embodiment, the predetermined value is set as the distance between two sensor areas, namely, all the sensor areas within the square area formed by the coordinates X4˜X8 and Y4˜Y8 are located within the first scan area 301. However, the predetermined value can be determined by those having ordinary knowledge in the art according to the actual composition of the touch panel and the actual design requirement.

In addition, the user may also perform a sliding action on the touch panel 50 to change the touched sensor area from the sensor area A to the sensor area B. Namely, after the user performs the sliding action, the sensor area A is changed to an un-touched state, while the sensor area B is changed to a touched state. This change caused by the sliding action is only taken as an example for describing the present embodiment, and the actual situation may be different. Herein, a second touch signal within the sensor area B is detected, and the first touch signal within the sensor area A cannot be detected. Thereafter, the scan area is adjusted as described above according to the second touch signal, so that the scan area 301 is changed to the scan area 302. Next, the scan area 302 is scanned to detect whether the sensor areas within the scan area 302 are touched. Similarly, if the touched sensor area is changed from the sensor area B to the sensor area C, the scan area is adjusted from the scan 302 to the scan area 303. Accordingly, when the user performs a sliding action to the touch panel 50 (i.e., the touch panel 50 is constantly touched), the number of sensor areas to be scanned (i.e., the area to be scanned) is reduced, and accordingly the scanning time is shortened.

Next, how to define a scan area when the touch panel is in the multi-touch state will be described. FIG. 4 is a diagram illustrating how to define a scan area in the multi-touch state according to the embodiment illustrated in FIG. 2. Referring to FIG. 2 and FIG. 4, when the first sensor area A and the second sensor area D of the touch panel 50 are touched, the sensor area A and the sensor area D respectively generate a touch signal, and the touch signals are detected when the sensor areas A and D are scanned. After scanning all the sensor areas on the touch panel 50, the touch panel 50 is determined to be in a multi-touch state (step S203). Then, the scan area is defined as the sensing range of the touch panel 50 (step S204), so as to scan all the sensor areas of the touch panel 50. Besides, whether the sensor areas A and D are constantly touched and whether any other sensor area is touched is determined according to the detection result of the touch signals, so as to detect whether the user performs a multi-touch sliding action or stops touching the touch panel 50. Foregoing number of sensor areas touched in the multi-touch state is only taken as an example for describing the present embodiment, and the number and dispositions of the sensor areas on the touch panel 50 may differ along with different devices adopted.

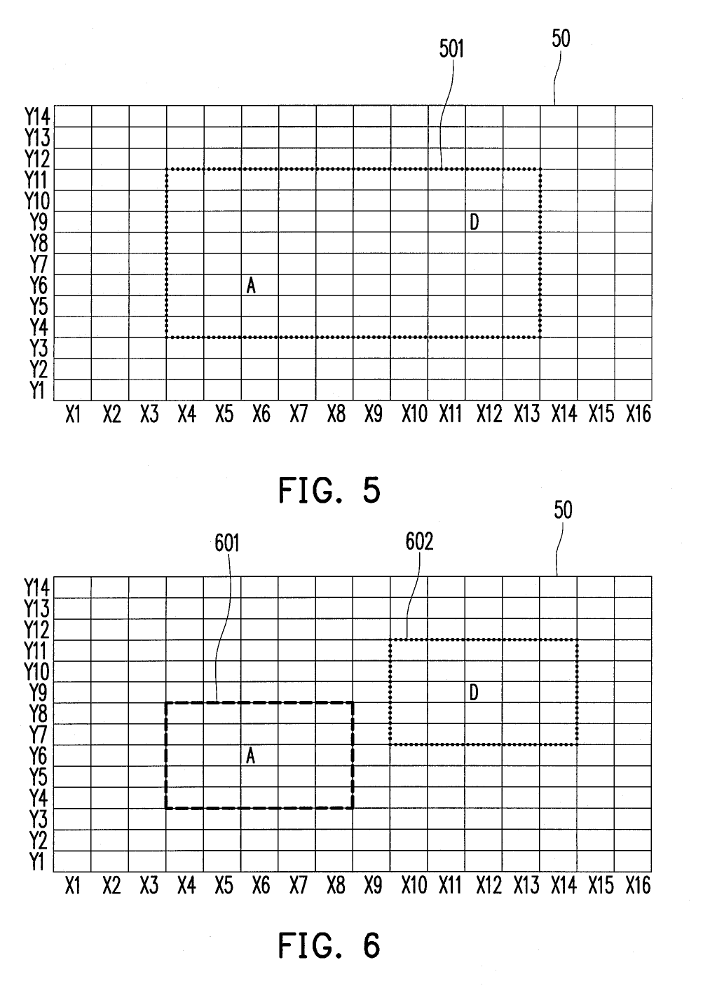

The scan area may not be the same as the sensing range of the touch panel in the multi-touch state, which will be explained below. FIG. 5 is a diagram illustrating how another scan area is defined in the multi-touch state according to the embodiment illustrated in FIG. 2. Referring to FIG. 4 and FIG. 5, the difference between the two embodiments falls on the definition of the scan area. In the present embodiment, a predetermined value is added to a maximum coordinate on the axis X (the first axis) of the sensor areas A and D (i.e., the first maximum coordinate), and the sum is served as an upper border (i.e., the first border) of the scan area 501, and the predetermined value is deducted from a minimum coordinate (i.e., the first minimum coordinate) of the two, and the result is served as a low border (i.e., the second border) of the scan area 501. Next, the predetermined value is added to a maximum coordinate (i.e., the second maximum coordinate) on the axis Y (the second axis) of the sensor areas A and D, and the sum is served as a right border of the scan area 501, and the predetermined value is deducted from a minimum coordinate (i.e., the second minimum coordinate) of the two, and the result is served as a left border of the scan area 501. In other words, the coordinate Y11 is the upper border of the scan area 501, the coordinate Y4 is the lower border of the scan area 501, the coordinate X13 is the right border of the scan area 501, the coordinate X4 is the left border of the scan area 501, and the square area formed by foregoing borders is the scan area 501.

It should be noted that more than two sensor areas may be touched. In this case, the coordinates of these sensor areas on the axis X and the axis Y are respectively compared to obtain the maximum coordinate and the minimum coordinate of the sensor areas on the axis X and the axis Y. Besides, the predetermined value is added to the maximum coordinate, and the predetermined value is deducted from the minimum coordinate, so as to define the borders of the scan area.

Moreover, a scan area may be further divided into a plurality of sub scan areas to reduce the number of sensor areas to be scanned. FIG. 6 is a diagram illustrating how yet another scan area is defined in the multi-touch state according to the embodiment illustrated in FIG. 2. Referring to FIG. 2 and FIG. 6, when the touch panel 50 is in the multi-touch state (step S203), a first sub scan area 601 and a second sub scan area 602 are respectively defined in the scan area according to the sensor area A and the sensor area D (step S408), wherein the sensor area A is located within the scan area 601, and the sensor area D is located within the scan area 602. The method for defining the scan areas 601 and 602 can be referred to the description of the scan area 301 and will be not described herein. In addition, when the sub scan areas of a scan area produce overlapped areas, which areas are overlapped is first determined, and those overlapped areas are only scanned once, so that the scanning time will not be prolonged.

As described above, the present invention provides a method of scanning a touch panel, wherein after a touch signal is detected, a scan area is defined according to the touched sensor areas corresponding to the touch signal. Besides, if the touch panel is constantly touched, only the sensor areas within the scan area are scanned, so that the number of sensor areas to be scanned can be reduced and the execution efficiency of the touch panel is improved. Moreover, according to the present invention, all the sensor areas are scanned after a predetermined period so that it can be detected if the user touches at sensor areas outside of the scan area.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method of scanning a touch panel, wherein the touch panel has a plurality of sensor areas, the method comprising:
(a) scanning the touch panel to detect whether the sensor areas are touched;
(b) when a first touch signal is detected, defining a scan area according to coordinates of the first touch signal, wherein the coordinates of the first touch signal are located within the scan area, and the scan area is smaller than a sensing range of the touch panel;
(c) scanning the scan area during a predetermined period to detect whether the sensor areas within the scan area are touched; and
(d) returning to step (a) after the predetermined period to re-scan the sensor areas of the touch panel.

2. The method according to claim 1, wherein the step of defining the scan area according to the coordinates of the touch signal comprises:
when the touch signal is corresponding to a first sensor area among the sensor areas, defining the scan area according to coordinates of the first sensor area.

3. The method according to claim 2, wherein the scan area is a square area, and the first sensor area is located at a center of the scan area.

4. The method according to claim 1, wherein the step of defining the scan area according to the coordinates of the touch signal comprises:
when the touch signal is corresponding to a first sensor area and a second sensor area among the sensor areas, defining the scan area according to coordinates of the first sensor area and the second sensor area.

5. The method according to claim 4, wherein the scan area is a square area.

6. The method according to claim 5, wherein the step of defining the scan area according to the coordinates of the first sensor area and the second sensor area comprises:
obtaining a first maximum coordinate and a first minimum coordinate on a first axis and a second maximum coordinate and a second minimum coordinate on a second axis according to the coordinates of the first sensor area and the second sensor area;
defining a first border and a second border of the scan area according to the first maximum coordinate and the first minimum coordinate, wherein the first border and the second border are opposite to each other; and
defining a third border and a fourth border of the scan area according to the second maximum coordinate and the second minimum coordinate, wherein the third border and the fourth border are opposite to each other.

7. The method according to claim 6, wherein coordinate of the first border and the first maximum coordinate are different by a predetermined value, and coordinate of the second border and the first minimum coordinate are different by the predetermined value.

8. The method according to claim 1, wherein the step of defining the scan area according to the coordinates of the touch signal comprises:
when the touch signal is corresponding to a first sensor area and a second sensor area among the sensor areas, respectively defining a first sub scan area and a second sub scan area of the scan area according to coordinates of the first sensor area and the second sensor area.

9. The method according to claim 8, wherein the first sub scan area and the second sub scan area are respectively a square area, the first sensor area is located at a center of the first sub scan area, and the second sensor area is located at a center of the second sub scan area.

10. The method according to claim 1, wherein the step of defining the scan area according to the coordinates of the touch signal comprises:
when a second touch signal is detected, adjusting a position of the scan area according to coordinates of the second touch signal, wherein the coordinates of the second touch signal are located within the adjusted scan area, and the second touch signal is detected after the first touch signal.

11. The method according to claim 1, wherein the sensor areas respectively comprise a sensor element.

12. A method of scanning a touch panel, wherein the touch panel has a plurality of sensor areas, the method comprising:
(a) scanning the touch panel to detect whether the sensor areas are touched;
(b) when a first touch signal is detected, defining a scan area according to coordinates of the first touch signal, wherein when the first touch signal is corresponding to a single sensor area, the scan area is smaller than a sensing range of the touch panel, when the first touch signal is corresponding to multiple sensor areas, the scan area is equal to the sensing range of the touch panel, and the coordinates of the touch signal are located within the scan area;
(c) scanning the scan area during a predetermined period to detect whether the sensor areas within the scan area are touched; and
(d) returning to step (a) after the predetermined period to re-scan the sensor areas of the touch panel.

13. The method according to claim 12, wherein the scan area is a square area, and the first sensor area is located at a center of the scan area.

14. The method according to claim 12, wherein the sensor areas respectively comprise a sensor element.
